(19) United States
(12) Patent Application Publication
(10) Pub. No.: US 2017/0195828 A1
(43) Pub. Date: Jul. 6, 2017

(54) PTP INTERACTION ASSOCIATION SYSTEM SUPPORTING CONNECTION BETWEEN MULTIMEDIA ELECTRONIC PRODUCT AND INTERNET

(71) Applicant: Yimwai YAU, Hong Kong (CN)

(72) Inventor: Yimwai YAU, Hong Kong (CN)

(21) Appl. No.: 15/309,173

(22) PCT Filed: May 4, 2015
(86) PCT No.: PCT/CN2015/078206

§ 371 Date: Jan. 22, 2017

(30) Foreign Application Priority Data
May 4, 2014 (CN) 201420234008.X
May 5, 2014 (CN) 201420237385.9
May 5, 2014 (CN) 201420237440.4
Sep. 4, 2014 (CN) 201420518969.3

(51) Int. Cl. H04W 4/00; H04L 29/08; H04W 76/02; G06F 17/30

(52) U.S. Cl. CPC H04W 4/008; G06F 17/30887; H04L 67/06; H04L 67/02; H04W 76/023; H04W 84/12

(57) ABSTRACT

The invention relates to a kind of Internet of Things technology, and particularly to a PTP interactive interconnected system supporting a connection of an electronic multimedia product with the Internet. The system comprises a communication terminal product supporting the PTP interactive interconnected system, a URL electronic data device, an electronic multimedia product and a numeric mark. A video image of the electronic multimedia product is attached with the numeric mark; the communication terminal product supports the input of a numeric character corresponding to the numeric mark; and an operating system of the communication terminal product receives an instruction from the numeric mark, calls out paired URL electronic data stored in the URL electronic data device, and sends a relevant request to a back-end server after processing the paired URL electronic data, and the back-end server returns an electronic file associated with the URL electronic data according to the relevant request.

### BACKGROUND OF THE INVENTION

1. Technical Field

The present invention relates to a kind of Internet of Things technology, and in particular to a PTP interactive interconnected system supporting a connection of an electronic multimedia product with the Internet to provide technical support enabling achieved Internet Plus for a traditional industry.

2. Description of Related Art

An advertising product based on traditional media is significantly behind that of electronic media in transmission capability, nevertheless, it is absolutely not the fact that “an ultimate form of mass media may replace any one of media such as traditional print media, traditional broadcasting, traditional television and traditional Internet”, as promoted by some people.

Information accessibility includes two major categories: one is network accessibility, and the construction of website accessibility falls under the category of network accessibility issues; and the other is electronics and information technology accessibility, which is to address seamless cross-media interconnection.

The Internet Society of China provides a definition as follows: information accessibility refers to any person (including the healthy, the disabled, the young and the old) under any circumstances being able to get access to and make use of information equally and conveniently without barriers.

If a smart phone is used to log on to the Internet for the information related to a print media product and get access to richer relevant data through extension, an association technology is a necessary condition that cannot be crossed out.

At present, it is a mainstream concept to enable offline and online connection for a plane media product with the solution of two-dimensional barcode/quick response code patterns in the market. Even though a mature product and industry chain has formed regarding the two-dimensional barcode/quick response code patterns, there are many restrictions on the technical use conditions in actual operation, and this refer to the following restrictions:

1. a smart phone can scan a two-dimensional barcode/quick response code pattern only after downloading an appropriate application;

2. the clarity of the two-dimensional barcode/quick response code pattern;

3. the light for scanning the two-dimensional barcode/quick response code pattern;

4. the distance for scanning the two-dimensional barcode/quick response code pattern;

5. the two-dimensional barcode/quick response code pattern is not uniform in size and its attachment may affect the aesthetic appearance of an advertising board;

6. with each two-dimensional barcode/quick response code pattern corresponding to one URL electronic data, there are numerous two-dimensional barcode/quick response code patterns present so as to meet the market demand, which can be expected to lead to chaos; and

7. the two-dimensional barcode/quick response code pattern is embedded into a screen picture of a video product or a webpage;

(1) during actual operation, the time for an electronic screen to display the two-dimensional barcode/quick response code pattern is very short, and it is difficult for a user to conduct the operation;

(2) in case of a non-high definition video image, the two-dimensional barcode/quick response code pattern is caused to distort and thus becomes unreadable; and

(3) in case of wobbling public transportation, the two-dimensional barcode/quick response code pattern is very difficult to read.

It is particularly emphasized that the solution of two-dimensional barcode/quick response code patterns is less competent to address the connection involving an audio/video product (an audio information technology).

Today, science and technology have entered into the era of human-computer interaction. In the public places of major cities, with the convergence between mobile networks and fixed networks, information accessibility is a technical barrier that cannot be crossed out for accessing the Internet anytime anywhere through a smart phone and achieving the development goal of smart cities.

As an important part of the new generation of information technology, the Internet of Things has been widely applied to network convergence, and thus is also known as the third wave following computer and Internet, in the development of the information industry around the world.

First, the Internet of Things still takes Internet as its core and foundation, and it is a network extending and expanding based on the Internet; and second, the clients of the Internet of Things have extended and expanded among any items for information exchange and communication, that is, things are closely linked.

As the Internet of Things technology develops continuously, there is an inevitable development trend of deep convergence between traditional industries and Internet technologies.

Therefore, there is an urgent expectation from the market to meet the requirements anytime anywhere at will with an easier, faster and more efficient Internet of Things technology.

### BRIEF SUMMARY OF THE INVENTION

To achieve the object above, the present invention provides a PTP interactive interconnected system supporting a connection of an electronic multimedia product with the Internet, comprising a communication terminal product supporting the PTP interactive interconnected system, a URL electronic data device, an electronic multimedia product and a numeric mark, wherein the communication terminal product supports a remote communication function; the communication terminal product supports a short distance communication function; and the URL electronic data device consists of a built-in URL electronic data device, a trigger URL electronic data device and URL electronic data transmission device; the URL electronic data device stores a URL electronic data combination; a video image of the electronic multimedia product is attached with the numeric mark; the communication terminal product supports the input of a numeric character corresponding to the numeric mark; and an operating system of the communication terminal product receives an instruction from the numeric mark, calls out paired URL electronic data stored in the URL electronic data device, and sends a relevant request to a back-end server after processing the paired URL electronic data, and the back-end server returns an electronic file associated with the URL electronic data according to the relevant request.

The communication terminal product supports the remote communication function, and requests a relevant telecommunication network to return an electronic file associated with the URL electronic data.

The communication terminal product supports WIFI (Wireless Fidelity) technology, and requests a connected WIFI device to return an electronic file associated with the URL electronic data.

The short distance communication function of the communication terminal product supports Bluetooth technology.

The URL electronic data device sends the URL electronic data containing an identifier code of the PTP interactive interconnected system by means of Bluetooth technology.

The URL electronic data device consists of a built-in URL electronic data device , an automatic trigger URL electronic data device and URL electronic data transmission device.

The built-in URL electronic data device is equipped in the communication terminal product, and the built-in URL electronic data device stores an raw URL electronic data combination.

The automatic trigger electronic data device is equipped in the electronic multimedia product, and sends the URL electronic data based on a time condition set by the electronic multimedia product to activate the raw URL electronic data combination stored in the built-in URL electronic data device of the communication terminal product and transforms the raw URL electronic data combination into another new set of URL electronic data combination.

The automatic trigger URL electronic data device continuously sends single URL electronic data in a set time.

The numeric mark with which the video image of the electronic multimedia product is attached is correspondingly paired with the URL electronic data combination stored in the URL electronic data device.

The video image of the electronic multimedia product is provided with a light source function system, and the URL electronic data sent by the automatic trigger URL electronic data device is matched with a change in a light source function.

The technology of the present invention is a URL electronic data transmission device supporting a PTP (Point to Page of Internet) interactive interconnected system, and provides technical support enabling the deep convergence between traditional industries and Internet technologies, and achieved Internet Plus.

1. The technology of the present invention employs the URL electronic data of the international standard technology as a media technology for the interactive interconnected system, and the communication terminal product supports the input of the corresponding numeric character according to the numeric mark, truly enabling barrier-free connection.

2. With the simplest point to point connection technology, a new technical direction of solution is provided regarding the big data congestion problem confronted by the development of the Internet.

3. The URL electronic data stored in the URL electronic data device designed by the present invention is an raw URL electronic data combination, which may change as required through the functional support of the URL electronic data device, either meeting numerous user requirements in the market or preventing the chaos caused by the overlapping of numeric marks.

The present invention is obviously superior to the solution of two-dimensional barcode/quick response code patterns in the market and the relevant solutions of connection technologies in terms of both operation and effect, thereby meeting the vision of obtaining information anytime anywhere at will in the era of mobile information.

### BRIEF DESCRIPTION OF THE SEVERAL VIEWS OF THE DRAWINGS

FIG. 1A is a schematic diagram of a structure of a technology of the present invention;

FIG. 1B is a schematic diagram of a structure used by the technology of the present invention;

FIG. 2A is a schematic diagram 1 of a working principle of the URL electronic data device;

FIG. 2B is a schematic diagram 2 of a working principle of the URL electronic data device;

FIG. 3A is a schematic diagram 1 of a point to point principle of the technology of the present invention;

FIG. 3B is a schematic diagram 2 of a point to point principle of the technology of the present invention;

FIG. 4A is a schematic diagram of an electronic multimedia product employing a two-dimensional barcode/quick response code pattern;

FIG. 4B is a schematic diagram of an effect of an electronic multimedia product employing the Q-card technology; and

FIG. 4C is a schematic diagram of an effect of an electronic multimedia product employing the technology of the present invention.

### DETAILED DESCRIPTION OF THE INVENTION

The following embodiments are intended to further explain and illustrate the present invention, instead of setting any limit to the present invention.

The present invention provides a PTP interactive interconnected system supporting a connection of an electronic multimedia product with the Internet, comprising a communication terminal product 38 supporting the PTP interactive interconnected system, a URL electronic data device 90, an electronic multimedia product 71 and a numeric mark, wherein the communication terminal product supports a remote communication function; the communication terminal product supports a short distance communication function; and the URL electronic data device 90 consists of a built-in URL electronic data device 91, a trigger URL electronic data device 93 and URL electronic data transmission device; the URL electronic data device 90 stores a URL electronic data combination; a video image of the electronic multimedia product 71 is attached with the numeric mark; the communication terminal product supports the input of a numeric character corresponding to the numeric mark; and an operating system of the communication terminal product receives an instruction from the numeric mark, calls out paired URL electronic data stored in the URL electronic data device 90, and sends a relevant request to a back-end server after processing the paired URL electronic data, and the back-end server returns an electronic file associated with the URL electronic data according to the relevant request.

The communication terminal product supports the remote communication function, and requests a relevant telecommunication network to return an electronic file associated with the URL electronic data.

The communication terminal product supports WIFI (Wireless Fidelity) technology, and requests a connected WIFI device to return an electronic file associated with the URL electronic data.

The short distance communication function of the communication terminal product supports Bluetooth technology, and obtains the URL electronic data from a relevant external product.

The URL electronic data device sends the URL electronic data containing an identifier of the PTP interactive interconnected system by means of Bluetooth technology.

When the communication terminal product is within a transmission range of the URL electronic data, the communication terminal product supporting the PTP interactive interconnected system can display a PTP information sensing symbol.

The specific operation of the technology of the present invention is divided into two types of methods as follows.

The first method: a user presses a PTP functional key to immediately receive the electronic file linked to the URL electronic data sent by the URL electronic data device.

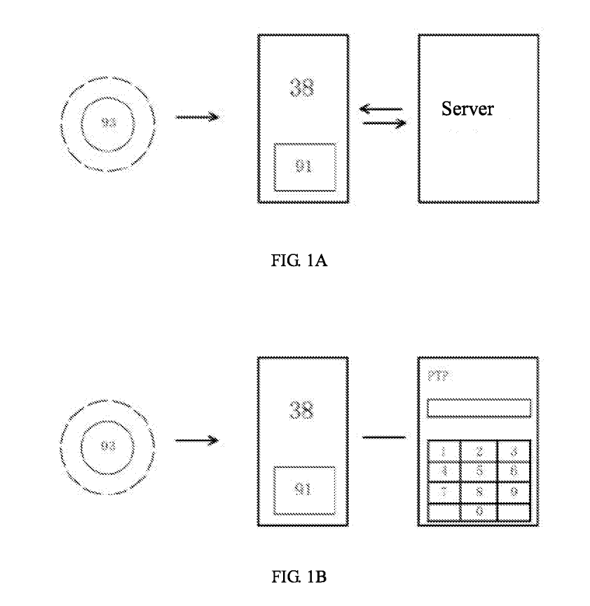

As shown in FIG. 1A, the returned electronic file is browsed through a display screen of the communication terminal product.

The second method: a user presses a PTP functional key so that a PTP operation interface appears on the display screen of the communication terminal product, and then selects a different numeric character as required to conduct an operation.

As shown in FIG. 1B, the URL electronic data device 90 consists of a built-in URL electronic data device (91) and an automatic trigger URL electronic data device 94.

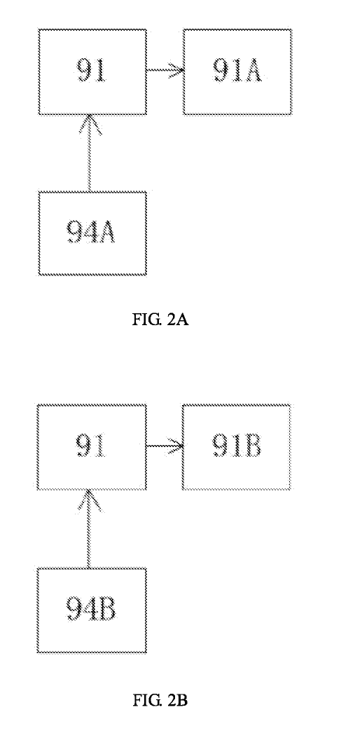

As shown in FIG. 2,

the built-in URL electronic data device is equipped in the communication terminal product. The built-in URL electronic data device stores an raw URL electronic data combination.

the automatic trigger URL electronic data device 94 is equipped in the electronic multimedia product 71. The automatic trigger URL electronic data device sends the URL electronic data based on a time condition set by the electronic multimedia product to activate the raw URL electronic data combination stored in the built-in URL electronic data device 91 of the communication terminal product and transforms the same into raw URL electronic data combination new set of URL electronic data combination.

Not only can numerous user requirements in the market be met, but also the chaos caused by the overlapping of numeric marks is prevented.

The numeric character of the numeric mark is correspondingly paired with the URL electronic data stored in the URL electronic data device 90.

As shown in FIG. 2A, a design solution of the present embodiment is as follows: the raw URL electronic data combination of the built-in URL electronic data device 91 is a series of 0000+(0001˜9999); the automatic trigger URL electronic data device 94A has the URL electronic data of 0001, activates the raw URL electronic data combination stored in the built-in URL electronic data device 91 of the communication terminal product and transforms the raw URL electronic data combination into another new set of URL electronic data combination; and the raw URL electronic data combination is transformed from the series of 0000+(0001˜9999) into the series of 0001+(0001˜9999).

As shown in FIG. 2B, a design solution of the present embodiment is as follows: the raw URL electronic data combination of the built-in URL electronic data device 91 is a series of 0000+(0001˜9999); the automatic trigger URL electronic data device 94B has the URL electronic data of 0033, activates the raw URL electronic data combination stored in the built-in URL electronic data device 91 of the communication terminal product and transforms the raw URL electronic data combination into another new set of URL electronic data combination; and the raw URL electronic data combination is transformed from the series of 0000+(0001˜9999) into the series of 0033+(0001˜9999).

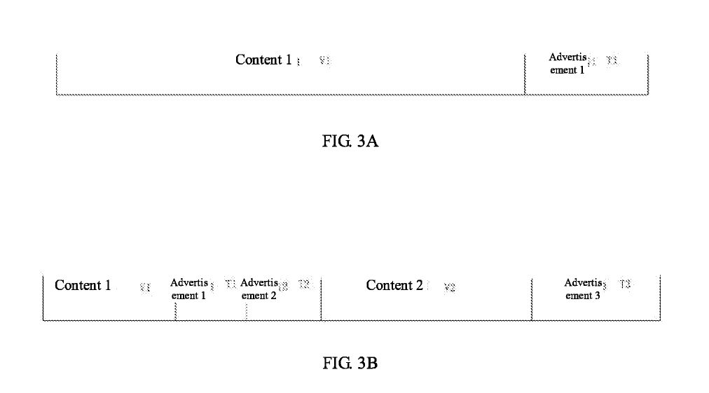

The automatic trigger URL electronic data device 94 continuously sends single URL electronic data in a set time, as shown in FIG. 3A.

If necessary, the URL electronic data transmission device can be set to continuously send a plurality of URL electronic data series in a set time, as shown in FIG. 3B.

The numeric mark with which the video image of the electronic multimedia product 71 is attached is correspondingly paired with the URL electronic data combination stored in the URL electronic data device 90.

The visual image of the electronic multimedia product is provided with a light source function system, and the URL electronic data sent by the automatic trigger URL electronic data device 94 is matched with a change in a light source function.

A user operates through a smart phone under the guidance of the change in a video image light source function of the electronic multimedia product, thereby achieving a point to point effect.

The electronic multimedia products include advertisement boards of public electronic media, indicator boards for public traffic, publication and guide boards for public tourism, guide boards for emergency services, public bus shelters, taxi call service shelters and the like.

The automatic trigger URL electronic data device can be assembled with a multimedia set top box product.

Sources linked to the URL electronic data are from various aspects, including memory, cloud storage, webpages based on login settings and the like, and the relevant technologies will not be explained in detail any more since they are extremely conventional and common in the market.

To improve the efficiency of a traditional product, there have been different technical solutions in the market, including the solution of two-dimensional barcode/quick response code patterns, the solution of NFC technology and the solution of RFID technology and the like. Relevant technical solutions and the application of the technology of the present invention are compared as follows.

For the electronic multimedia product, a user needs to enter a website to conduct a connection operation if he/she wants to obtain the further information content of the product, which is quite troublesome.

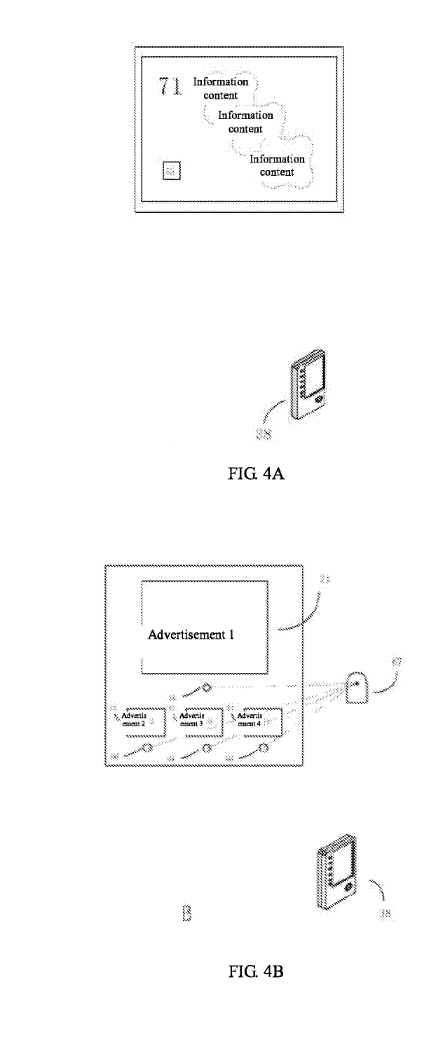

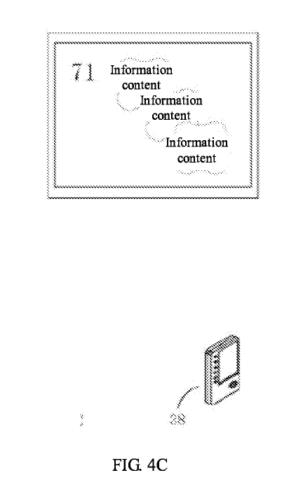

In Embodiment 1, as shown in FIG. 4A, the electronic multimedia product is embedded with a two-dimensional barcode/quick response code pattern 52 (a print information technology) to enable a visitor to log on to a website of the relevant electronic address data and follow the relevant advertising content, with the steps as follows:

1. scanning a two-dimensional barcode/quick response code pattern and processing and transforming the same into URL electronic data, through a smart phone;

2. logging on to the website of the relevant URL electronic data; and

3. conducting a traditional webpage search operation.

The following provides relevant embodiments of the technology of the present invention.

In Embodiment 2, as shown in FIG. 4B, there is a large media company employing an interactive screen solution based on RFID technology, and compared with a traditional advertising display screen, three small interactive induction screens are added below an original single display screen and act as carriers for an interactive transmission platform.

An operation method is as follows: since a Q card is a unique key to enable this platform, a user needs to apply for an RDID card (the Q card) and send a short message from a mobile phone to activate the card according to the prompts after receiving the card, then, the user may swipe the Q card on an inductive area of the interactive screen, and special offers displayed in the advertising screen will be sent to the mobile phone in a short message form.

Compared with the traditional advertising screen, the interactive screen solution has three small interactive induction screens added below the original single display screen and takes them as carriers for an interactive transmission platform. There are many obstacles encountered in the actual operation.

In case of a Q card plan where a user is required to carry the Q card and a mobile phone, the user needs to pursue interaction within a short time of two minutes, which is an excessively high-demanding challenge in itself.

In Embodiment 3, as shown in FIG. 4C, after an electronic multimedia product employs the technology of the present invention, a corresponding numeric character 03 is entered into the communication terminal product 38 (a smart phone) according to an numeric mark (a guide) of the electronic multimedia product; and an operating system of the communication terminal product receives an instruction from the numeric mark, calls out URL electronic data paired with 03 and stored in the URL electronic data device 90, and sends a relevant request to a back-end server after processing the paired URL electronic data, the back-end server returns an electronic file associated with the URL electronic data of 03 according to the relevant request, and the electronic file is browsed through a display screen of the communication terminal product.

The technology of the present invention provides a technical solution having a category different from that of the solution of two-dimensional barcode/quick response code patterns, and thus has distinct effects as follows:

1. basically no limit from distance;

2. basically no impact from light conditions;

3. accuracy superior to that of the solution of two-dimensional barcode/quick response code patterns; and

4. fewer impacts to the aesthetic appearance of an advertising board due to substitution of the two-dimensional barcode/quick response code pattern with the numeric character.

With reference to the effects of the relevant embodiments above, the technology of the present invention is obviously superior in terms of operation, fabrication cost and transmission effect compared with relevant technical solutions and product solutions in the market, and the technology of the present invention will be further developed to affect all the links of a commercial chain and create a brand-new form of commercial mode and value chain.

Though the technology of the present invention is disclosed with the embodiments above, the scope of the technology of the present invention is not limited thereto, and all the components above may be substituted with other similar or equivalent elements known to those skilled in the art without departing from the conception of the technology of the present invention.

1. A PTP interactive interconnected system supporting a connection of an electronic multimedia product with the Internet, comprising a communication terminal product supporting the PTP interactive interconnected system, a URL electronic data device, an electronic multimedia product and a numeric mark, wherein
the communication terminal product supports a remote communication function;
the communication terminal product supports a short distance communication function; and
the URL electronic data device consists of a built-in URL electronic data device, a trigger URL electronic data device and URL electronic data transmission device;
the URL electronic data device stores a URL electronic data combination;
a video image of the electronic multimedia product is attached with the numeric mark;
the communication terminal product supports the input of a numeric character corresponding to the numeric mark; and
an operating system of the communication terminal product receives an instruction from the numeric mark, calls out paired URL electronic data stored in the URL electronic data device, and sends a relevant request to a back-end server after processing the paired URL electronic data, and the back-end server returns an electronic file associated with the URL electronic data according to the relevant request.

2. The PTP interactive interconnected system supporting the connection of the electronic multimedia product with the Internet of claim 1, wherein the communication terminal product supports the remote communication function, and requests a connected telecommunication network to return an electronic file associated with the URL electronic data.

3. The PTP interactive interconnected system supporting the connection of the electronic multimedia product with the Internet of claim 1, wherein the communication terminal product supports WIFI (Wireless Fidelity) technology, and requests a connected WIFI device to return an electronic file associated with the URL electronic data.

4. The PTP interactive interconnected system supporting the connection of the electronic multimedia product with the Internet of claim 1, wherein the short distance communication function of the communication terminal product supports Bluetooth technology.

5. The PTP interactive interconnected system supporting the connection of the electronic multimedia product with the Internet of claim 1, wherein the URL electronic data transmission device sends the URL electronic data containing an identifier of the PTP interactive interconnected system by means of Bluetooth technology.

6. The PTP interactive interconnected system supporting the connection of the electronic multimedia product with the Internet of claim 1, wherein the URL electronic data device consists of a built-in URL electronic data device and an automatic trigger URL electronic data device.

7. The PTP interactive interconnected system supporting the connection of the electronic multimedia product with the Internet of claim 6, wherein the built-in URL electronic data device is equipped in the communication terminal product, and the built-in URL electronic data device stores an raw URL electronic data combination.

8. The PTP interactive interconnected system supporting the connection of the electronic multimedia product with the Internet of claim 6, wherein the automatic trigger URL electronic data device is equipped in the electronic multimedia product, and sends the URL electronic data based on a time condition set by the electronic multimedia product to activate the raw URL electronic data combination stored in the built-in URL electronic data device of the communication terminal product and transforms the raw URL electronic data combination into another new set of URL electronic data combination.

9. The PTP interactive interconnected system supporting the connection of the electronic multimedia product with the Internet of claim 1, wherein the automatic trigger URL electronic data device continuously sends single URL electronic data in a set time.

10. The PTP interactive interconnected system supporting the connection of the electronic multimedia product with the Internet of claim 1, wherein the numeric mark attached at video image of the electronic multimedia product is correspondingly paired with the URL electronic data combination stored in the URL electronic data device.

11. The PTP interactive interconnected system supporting the connection of the electronic multimedia product with the Internet of claim 1, wherein the video image of the electronic multimedia product is provided with a light source function system, and the URL electronic data sent by the automatic trigger URL electronic data device is matched with a change in a light source function.
